(19) United States
(12) Patent Application Publication
(10) Pub. No.: US 2014/0335334 A1
(43) Pub. Date: Nov. 13, 2014

(54) PROTECTIVE FILM

(71) Applicant: ALPHA OPTICAL CO., LTD, Kaohsiung City (TW)

(72) Inventors: Chi-Jen Huang, Kaohsiung City (TW); Wei-Chang Wang, Kaohsiung City (TW); Ping-Yuan Tsai, Kaohsiung City (TW); Chia-Che Wu, Kaohsiung City (TW); Wan-Ting Lin, Kaohsiung City (TW); Li-Zhang Su, Kaohsiung City (TW)

(73) Assignee: Alpha Optical Co., Ltd, Kaohsiung City (TW)

(21) Appl. No.: 13/889,355

(22) Filed: May 8, 2013

(51) Int. Cl. C09J 7/02; C09J 131/04; C09J 153/02; C09J 123/02; C09J 109/06; C09J 125/08

(52) U.S. Cl. CPC C09J 7/0275; C09J 109/06; C09J 125/08; C09J 153/02; C09J 123/02; C09J 131/04; C09J 2423/106; C09J 2423/046; C09J 2203/30; C09J 2453/00; C09J 2409/00; C09J 2425/00; C09J 2423/00; C09J 2431/00
USPC 428/213; 428/352

(57) ABSTRACT

A protective film includes a non-adhesion layer and adhesion layer, and the non-adhesion layer further includes a surface layer and middle layer, where the surface layer of the non-adhesion layer is formed from a blend of Homo-polypropylene(H-PP) and low density polyethylene(LDPE), the middle layer of the non-adhesion layer is formed from a blend of high density Polyethylene(HDPE) and LDPE among Polyethylene series, and the adhesion layer is formed from thermoplastic elastomer added with low hardness plastic material, allowing the protective film of the present invention not to yield melting and thus sticking issues easily, and ensuring that the protective film has a good attachment and unwinding nature on application.

### TECHNICAL FIELD OF THE INVENTION

The present invention relates to a protective film, and more particularly to a protective film, which can be cut without yielding stickling problems easily, and has a good attachment effect to an object on application.

### DESCRIPTION OF THE PRIOR ART

Referring to FIG. 1, a conventional protective film 1 has a surface layer 11, middle layer 12 and adhesive layer 13, where the surface layer 11 and middle layer 12 respectively are a substrate made from polyethylene(PE). One surface of the surface layer 11 is coupled to the middle layer 12, and one face of the middle layer 12 is coated with high viscosity adhesive. Using the high viscosity adhesive of the adhesive layer 13, the protective film 1 can be attached to a surface of an object, allowing the object to be under a definite degree of protection.

However, the protective film 1 may be applied to objects in many occasions, in particular, applied largely to objects such as optical sheets and films. Such kind of attached objects A are stacked together practically for the smooth going of manufacturing procedures, as FIG. 2 shows. But, the surface layer 11 of the protective film 1 is melted and the middle layer 12 thereof burred very easily when the stack is processed with pressing, cutting, polishing or etc, causing the two adjacent protective films 1 to be stuck to each other finally such that the upper and lower protective films 1 will be lifted together while the attached object is to be used afterwards, as FIG. 3 shows, causing perplexity during an operation, and affecting the smooth going of an operation flow seriously.

### SUMMARY OF THE INVENTION

To improve the deficiencies of conventional protective films mentioned above, such as the two protective films being stuck together due to the melting of the surface layer during cutting after cutting, burrs being yielded easily during cutting, and the protective film being not easy to be attached to an elastic object, the present invention is proposed.

A protective film according to the present invention includes a non-adhesion layer and adhesion layer, and the non-adhesion layer further includes a surface layer and middle layer, where the surface layer of the non-adhesion layer is formed from a blend of homo-polypropylene(H-PP) and low density polyethylene(LDPE), thereby preventing the protective film from melting during machining such as pressing, cutting or polishing after being attached to an object, the middle layer of the non-adhesion layer is formed from a blend of high density polyethylene(HDPE) and LDPE among polyethylene series, thereby reducing shearing force to prevent the formation of burrs and capable of providing good cutting machinability. Furthermore, the adhesion layer is formed from thermoplastic elastomer, low hardness and high adhesion allows the adhesion layer to have a good adhesion force and maintain a good unwinding nature so as to be applicable to the attachment to elastic objects, such as elastic prism sheet, or human skin. Therefore, film lifting and residual adhesive are not caused even at a normal or high temperature after the attachment.

### BRIEF DESCRIPTION OF THE DRAWINGS

FIG. 1 is a cross-sectional view of a conventional protective film;.

FIGS. 2 and 3 respectively are a schematic view of a conventional protective film while being put into practice; and

FIG. 4 is a cross-sectional view of a protective film of the present invention.

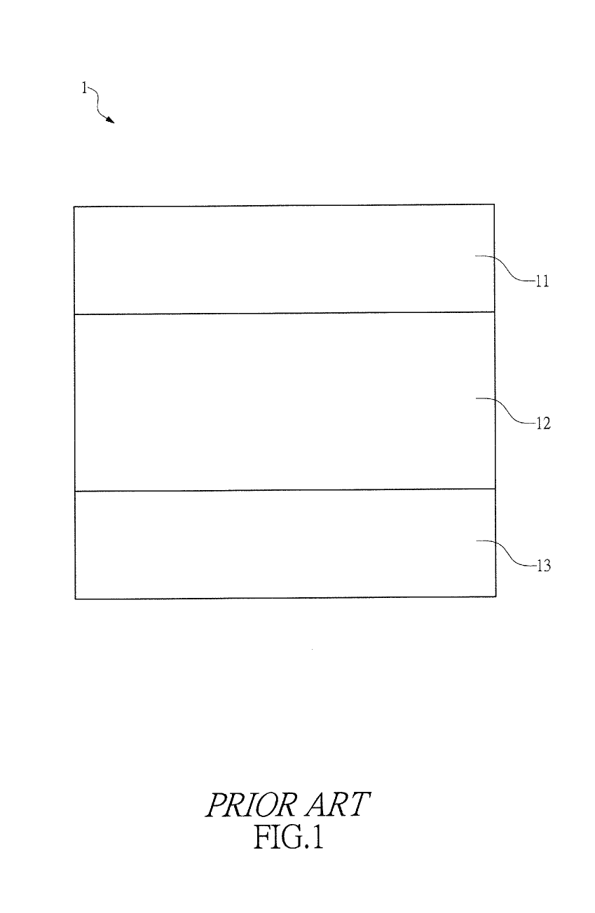

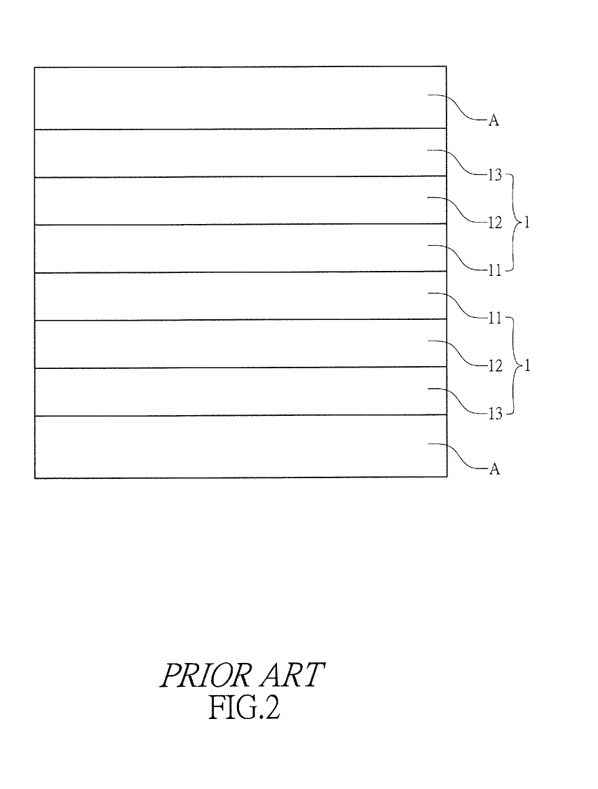

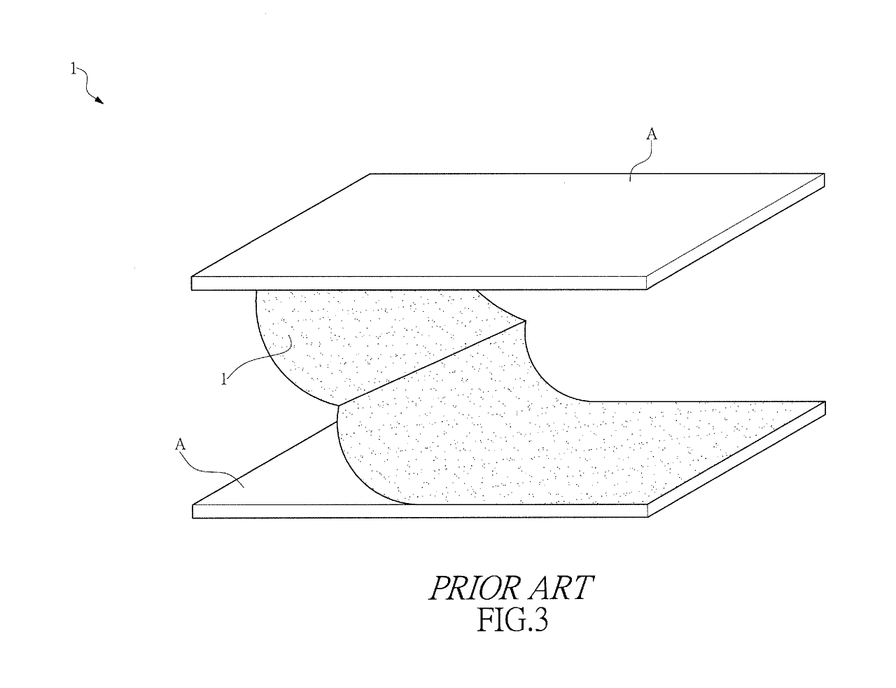

### DETAILED DESCRIPTION OF THE PREFERRED EMBODIMENTS

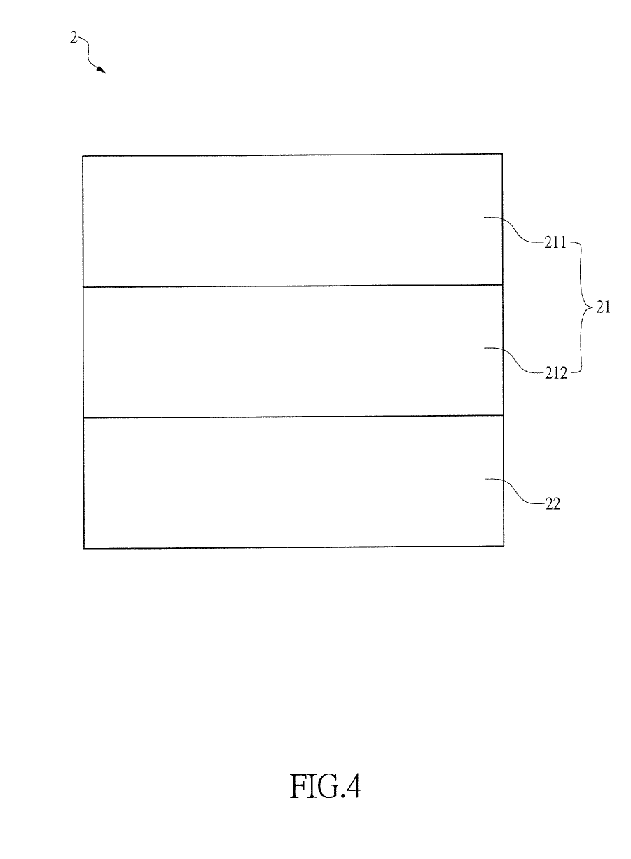

Referring to FIG. 4, a protective film 2 of the present invention includes a non-adhesion layer 21 and adhesion layer 22, where the non-adhesion layer 21 further includes a surface layer 211 and middle layer 212. The thickness of the entire protective film 2 is ranged between 10 and 100 μm, where the thickness of the surface layer 211 of the non-adhesion layer 21 is not larger than 20% of the thickness of the entire protective film 2, the thickness of the middle layer 212 is ranged between 60-90%, and the thickness of the adhesion layer 22 is ranged between 5-25%. Furthermore, the non-adhesion layer 21 and adhesion layer 22 is coupled to each other by means of co-extrusion without a coating operation, thereby reducing the production cost and avoiding environmental pollution due to coating.

Furthermore, the non-adhesion layer 21 is made from polyolefin among which polypropylene (PP) can be chosen, such as homo-PP, block-PP or random-PP; if the non-adhesion layer 21 is propylene, the melt flow rate(MFR) thereof may preferably be ranged between 1.0-30.0 g/10 min, or if the non-adhesion layer 21 is polyethylene such as low density polyethylene, high density polyethylene, or linear low density polyethylene, the melt flow rate(MFR) may preferably be ranged between 0.5-30.0 g/10 min. In addition, the non-adhesion layer 21 may also be chosen from a blend or copolymer of the materials mentioned above.

Furthermore, the polypropylene mentioned above may be home-PP, block-PP or random-PP with MFR ranged between 1.0-40.0 g/10 min, specific gravity ranged between 0.85-0.95 g/cm³ and elongation at fracture greater than or equal to 80%. Low density polyethylene has MFR ranged between 0.5-20.0 g/10 min, specific gravity ranged between 0.90-0.95 g/cm³ and elongation at fracture greater than or equal to 400%. High density polyethylene has MFR ranged between 0.1-20.0 g/10 min, specific gravity ranged between 0.85-0.95 g/cm³ and elongation at fracture greater than or equal to 200%.

In addition, the surface layer 211 of the non-adhesion layer is formed from the blend of the above Homo-PP and LDPE, where the blending ratio of the LDPE is ranged is greater than 0 and smaller than 30, thereby preventing the surface layers 211 from being melted and stuck to each other while being processed by pressing, cutting or polishing after protective film attached objects are stacked together on application.

Furthermore, the surface layer 211 of the non-adhesion layer may further added with a release agent, where the added release agent may be ranged between 20-90% by weight of the entire non-adhesion layer 21, thereby preventing the protective film 2 in use being wound, elongated and deformed or adhesive face from being damaged due to uneasy stripping, and elevating the unwinding nature performance thereof.

The middle layer 212 of the non-adhesion layer 21 is a layer made from the blend of HDPE and LDPE, where the MFR thereof is ranged between 0.5-30.0 g/10 min, and the blending ratio of LDPE is greater than 0 and smaller than 30%, thereby preventing burrs from being yielded on the layer body of the middle layer 212 after the protective film 2 is processed by pressing, cutting or polishing. Furthermore, the middle layer may further added with at least one HDPE layer or at least one LDPE layer, or both at least one HDPE and at least one LDPE layer, allowing the middle layer 212 to not only have a layer body of HDPE blended with LDPE, but also be a layer body further including at least one single HDPE layer, or at least one single LDPE layer, or both at least one HDPE layer and at least one LDPE layer, thereby forming the middle layer 212 into a multi-layer pattern to optimizing the rigidity and easy-cutting performance thereof.

The adhesion layer 22 is made from thermoplastic elastomer. The MFR of the thermoplastic elastomer is ranged between 0.5-10.0 g/10 min, preferably, 1.0-7.0 g/10 min, and more preferably, 2.0-5.0 g/10 min. The Shore A hardness thereof is below 50A, preferably, 45A, and more preferably, 40A. The thermoplastic elastomer may be hydrogenated styrene butadiene rubber(HSBR), styrene-ethylene/butylenes-styrene(SEBS), styrene-isoprene-styrene/styrene-isoprene block copolymer(SIS), styrene-ethylene/propylene-styene(SFPS), polyolefin elastomer(POE), ethylene vinyle acetate(EVA), or a blend or copolymer of the materials mentioned above, where the content of styrene in hydrogenated styrene butadiene rubber(HSBR) is ranged between 10-50%, MFR 1.0-15.0 g/10 min, specific weight 0.85-0.95 g/cm³ and Shore hardness 30A-70A; the content of styrene in styrene-ethylene/butylenes-styrene(SEBS) is ranged between 10-50%, MFR 1.0-15.0 g/10 min, specific weight 0.85-0.95 g/cm³ and Shore hardness 30A-90A; the content of styrene in styrene-isoprene-styrene/styrene-isoprene block copolymer(SIS) is ranged between 10-40%, MFR 1.0-15.0 g/10 min, specific weight 0.90-0.95 g/cm³ and Shore hardness 30A-70A; the content of styrene in styrene-ethylene/propylene-styene(SEPS) is ranged between 10-50%, MFR 1.0-15.0 g/10 min, specific weight 0.85-0.95 g/cm³ and Shore hardness 40A-90A; the MFR of polyolefin elastomer(POE) is ranged between 1.0-10.0 g/10 min, specific weight 0.80-0.90 g/cm³ and Shore hardness 50A-90A; and the MFR of ethylene vinyle acetate(EVA) is ranged between 1.0-20.0 g/10 min, specific weight 0.90-0.95 g/cm³ and Shore hardness 30A-90A.

Any one selected from a group constituted by hydrogenated styrene butadiene rubber(HSBR), styrene-ethylene/butylenes-styrene(SEBS), styrene-isoprene-styrene/styrene-isoprene block copolymer(SIS), styrene-ethylene/propylene-styene(SEPS), polyolefin elastomer(POE), ethylene vinyle acetate(EVA), and the blend or copolymer of the materials mentioned above is caused to be below 30A in Shore hardness to form a low hardness plastic material, and added below 70% by weight of the entire adhesion layer 22, thereby allowing the initial adhesion of the adhesion layer 22 to be increased.

Therefore, the adhesion layer 22 of the protective film 2 of the present invention is allowed to have a good adhesion and maintain a good unwinding nature so that it can be applied to the attachment to elastic objects having spring force, such as elastic prism sheets, human skin, or etc. whereby, film lifting are not caused and residual glue not yielded after the attachment of the protective film 2 even if it is at normal or high temperature, capable of bringing protection into full play indeed.

In addition, the adhesion layer 22 may further added with hydrocarbon tackifier resin, which has a specific weight ranged between 0.95-1.00, softening point ranged between 70-140° C., and glass transition temperature(Tg) ranged between 35-90° C., thereby increasing the adhesion force thereof. An addition amount of hydrocarbon tackifier resin may be greater than 0 and smaller than 70% by weight of the entire adhesion layer, preferably, ranged between 10=65%, and more preferably, ranged between 15-60% so as to master the high adhesion and low hardness thereof to reduce elastic recovering force after the attachment, thereby preventing a bad situation of film lifting.

The following shows a Table 1 of experiments; data obtained in Table 1 achieve the experimental results of the present invention, where a plastic material A is hydrogenated styrene butadiene rubber(HSBR) having a MFR ranged between 1.0-15.0 g/10 min, specific weight 0.85-0.95 g/cm³ and Shore hardness 30A-70A; styrene-ethylene/butylenes-styrene(SEBS) having a content of Styrene therein ranged between 10-50%, MFR 1.0-15.0 g/10 min, specific weight 0.85-0.95 g/cm³ and Shore hardness 30A-90A; styrene-ethylene/propylene-styene(SEPS) having a content of Styrene ranged between 10-50%, MFR 1.0-15.0 g/10 min, specific weight 0.85-0.95 g/cm³ and Shore hardness 40A-90A; polyolefin elastomer(POE) having a MFR ranged between 1.0-10.0 g/10 min, specific weight 0.80-0.90 g/cm³ and Shore hardness 50A-90A; ethylene vinyle acetate(EVA) having a MFR ranged between 1.0-20.0 g/10 min, specific weight 0.90-0.95 g/cm³ and Shore hardness 30A-90A; or styrene-isoprene-styrene/styrene-isoprene block copolymer(SIS) having a content of styrene ranged between 10-40%, MFR 1.0-15.0 g/10 min, specific weight 0.90-0.95 g/cm³ and Shore hardness 30A-70A. A plastic material B is one selected from a group constituted by hydrogenated styrene butadiene rubber(HSBR), styrene-ethylene/butylenes-styrene(SEBS), styrene-isoprene-styrene/Styrene-isoprene block copolymer(SIS), styrene-ethylene/propylene-styene(SEPS), polyolefin elastomer(POE), ethylene vinyle acetate(EVA), and a blend or copolymer of the materials mentioned above each having a Shore hardness below 30A. A plastic material C is a tackifier with a specific weight ranged between 0.95-1.00 g/cm³ and a softening point ranged between 70-140° C.

TABLE 1

| | | | | Film | | |
|---|---|---|---|---|---|---|
| | A | B | C | thickness | Film | Adhesion |
| | (%) | (%) | (%) | (μm) | formation | force |
| Embod. 1 | 20 | 30 | 50 | 6 | B | B |
| Embod. 2 | 20 | 10 | 70 | 6 | G | G |
| Embod. 3 | 25 | 20 | 55 | 6 | G | G |
| Embod. 4 | 30 | 10 | 60 | 6 | G | G |
| Embod. 5 | 35 | 30 | 35 | 6 | B | B |
| Embod. 6 | 35 | 50 | 15 | 6 | G | B |
| Embod. 7 | 40 | 10 | 50 | 6 | G | B |
| Embod. 8 | 40 | 12 | 48 | 6 | B | B |
| Embod. 9 | 42 | 30 | 28 | 6 | G | B |
| Embod. 10 | 45 | 20 | 35 | 6 | G | G |
| Embod. 11 | 45 | 25 | 30 | 6 | G | G |
| Embod. 12 | 50 | 0 | 50 | 6 | B | B |
| Embod. 13 | 50 | 15 | 35 | 6 | G | G |
| Embod. 14 | 50 | 20 | 30 | 6 | G | G |
| Embod. 15 | 50 | 50 | 0 | 9 | G | G |
| Embod. 16 | 55 | 10 | 35 | 6 | G | B |
| Embod. 17 | 70 | 0 | 30 | 6 | G | B |
| Embod. 18 | 75 | 0 | 25 | 6 | G | B |
| Embod. 19 | 80 | 0 | 20 | 6 | G | B |
| Embod. 20 | 80 | 20 | 0 | 9 | G | G |
| Embod. 21 | 100 | 0 | 0 | 6 | B | B |
| Embod. 23 | 0 | 50 | 50 | 9 | G | G |
| Embod. 24 | 0 | 70 | 30 | 10 | G | G |

### Where:

A, B and C are raw materials mentioned above;
Embod. is the abbreviation of embodiment;
Film formation—G: good, the face of a film is flat and neat during film making, the thickness of the film is uniform;
   B: bad, film formation cannot be completed during extrusion, stock feeding is not uniform, fisheyes are serious or thickness drop is too large;
Adhesion force—G: good, an adhesion force is 10-30 gf/25 mm at a normal temperature;
   B: bad, attachment does not work, or a film is lifted during a period of time of standing after attachment.

The embodiments 1, 5, 8, 12 and 21 in Table 1 respectively select one with MFR ranged between 2.0-12.0 g/10 mm among the raw material formulas mentioned above to be carried out with extrusion through three-axis co-extrusion molding machine. Uneven raw material feeding or film formation incapability might happen probably because of overlarge difference in MFR or bad interface flowability during extrusion.

The protective films of Embodiments 6, 7, 9, 16 and 19 in Table 1 respectively formed by selecting one with a MFR ranged between 3.0-8.0 g/10 min and Shore hardness ranged between 50-70A among the raw material formulas mentioned above are incapable of being attached to a respective object or lifting after 24 hours of standing at a normal temperature after being attached to the object through a calendar roller.

The protective films of Embodiments 2-4, 10-11, 13-15, 20 and 23-24 in Table 1 respectively formed by selecting one with a MFR ranged between 3.0-8.0 g/10 min and Shore hardness 45A among the raw material formulas mentioned above are not lifting even after 168 hours of standing at a normal temperature after being attached to the object through a calendar roller, where the plastic material B is used as an additive with a low hardness, which has a Shore hardness below 30A.

Furthermore, in the following Table 2, the composed non-adhesion layers 21 in Table 1 are respectively added with a release agent with a weigh ratio ranged between 20-90% of the total weight; it is clearly seen that the improvement on release force is obtained.

TABLE 2

| | | Release | |
|---|---|---|---|
| | Embod. | agent | Unwinding |
| | (Table 1) | (%) | nature |
| Embod. 1′ | Embod. 2 | 30 | Good |
| Embod. 2′ | Embod. 3 | 40 | Good |
| Embod. 3′ | Embod. 4 | 30 | Good |
| Embod. 4′ | Embod. 10 | 40 | Good |
| Embod. 5′ | Embod. 11 | 20 | Good |
| Embod. 6′ | Embod. 13 | 40 | Good |
| Embod. 7′ | Embod. 14 | 90 | Good |
| Embod. 8′ | Embod. 15 | 90 | Good |
| Embod. 9′ | Embod. 20 | 40 | Good |
| Embod. 10′ | Embod. 23 | 30 | Good |
| Embod. 11′ | Embod. 24 | 20 | Good |

### Where:

Embod. is the abbreviation of embodiment.

Unwinding nature—good, release force is approximately larger than or equal to 500 gf/25 mm;
bad. Incapable of unwinding or release force is smaller than 500 gf/25 mm.

It is clear that the embodiments 1′ to 11′ can perform a good unwinding nature.

I claim:

1. A protective film, comprising a non-adhesion layer and adhesion layer, said non-adhesion layer further comprising a surface layer and middle layer, wherein said non-adhesion layer is formed from one selected from a group constituted by blends or copolymers of both polypropylene series and polyethylene series, characterized in that said surface layer of said non-adhesion layer is formed from a blend of homo-polypropylene and low density polyethylene among said polyethylene series.

2. The protective film according to claim 1, wherein a thickness of said surface layer of said non-adhesion layer is not beyond 20% of a thickness of entire said protective film.

3. The protective film according to claim 1, wherein a melt flowing rate(MFR) of said polypropylene of said surface layer of said non-adhesion layer is ranged between 1.0-30.0 g/10 min.

4. The protective film according to claim 1, wherein a melt flow rate(MFR) of said polyethylene of said surface layer of said non-adhesion layer is ranged between 0.5-30.0 g/10 min.

5. The protective film according to claim 1, wherein a blending ratio of said low density polyethylene of said surface layer of said non-adhesion layer is larger than 0 and smaller than 30%.

6. The protective film according to claim 1, wherein said homo-polypropylene has a MFR ranged between 1.0-40.0 g/10 min, specific weight ranged between 0.90-0.95 g/cm³ and elongation at fracture larger than or equal to 80%.

7. The protective film according to claim 1, wherein said surface layer of said non-adhesion layer is further added with a release agent.

8. The protective film according to claim 7, wherein said added release agent is ranged between 20-90% by weight of said non-adhesion layer.

9. A protective film, comprising a non-adhesion layer and adhesion layer, said non-adhesion layer further comprising a surface layer and middle layer, wherein said non-adhesion layer is formed from one selected from a group constituted by blends or copolymers of both polypropylene series and polyethylene series, characterized in that said middle layer of said non-adhesion layer is formed from a blend of high density polyethylene and low density polyethylene among said polyethylene series.

10. The protective film according to claim 9, wherein a thickness of said middle layer of said non-adhesion layer is ranged between 60-95% of a thickness of entire said protective film.

11. The protective film according to claim 9, wherein a melt flowing rate(MFR) of said polyethylene of said middle layer of said non-adhesion layer is ranged between 0.5-30.0 g/10 min.

12. The protective film according to claim 9, wherein a blending ratio of said low density polyethylene of said middle layer of said non-adhesion layer is larger than 0 and smaller than 30%.

13. The protective film according to claim 9, wherein said middle layer of said non-adhesion layer further comprises at least one layer of high density polyethylene among said polyethylene series.

14. The protective film according to claim 9, wherein said middle layer of said non-adhesion layer further comprises at least one layer of low density polyethylene among said polyethylene series.

15. The protective film according to claim 9, wherein said middle layer of said non-adhesion layer further comprises both at least one layer of high density polyethylene and at least one layer low density polyethylene.

16. A protective film, comprising a non-adhesion layer and adhesion layer, characterized in that said adhesion layer is composed by thermoplastic elastomer and plastic material with a low hardness below 70% by weight of entire said adhesion layer, wherein said thermoplastic elastomer is any one selected from a group constituted by hydrogenated styrene butadiene rubber(HSBR), styrene-ethylene/butylenes-styrene(SEBS), styrene-isoprene-styrene/styrene-isoprene block copolymer(SIS), styrene-ethylene/propylene-styene(SEPS), polyolefin elastomer(POE), ethylene vinyle acetate(EVA), and a blend or copolymer thereof each with a Shore hardness more than 30A.

17. The protective film according to claim 16, wherein a thickness of said adhesion layer is ranged between 5-25% of a thickness of entire said protective film.

18. The protective film according to claim 16, wherein a content of styrene in said hydrogenated styrene butadiene rubber(HSBR) is ranged between 10-50%, MFR ranged between 0.5-10.0 g/10 min, specific weight 0.85-0.95 g/cm³ and Shore hardness 30A-70A.

19. The protective film according to claim 16, wherein a content of styrene in said styrene-ethylene/butylenes-styrene(SEBS) is ranged between 10-50%, MFR ranged between 1.0-15.0 g/10 min, specific weight 0.85-0.95 g/cm³ and Shore hardness 30A-90A.

20. The protective film according to claim 16, wherein a content of styrene in said styrene/styrene-isoprene block copolymer(SIS) is ranged between 10-40%, MFR ranged between 1.0-15.0 g/10 min, specific weight 0.90-0.95 g/cm³ and Shore hardness 30A-70A.

21. The protective film according to claim 16, wherein a content of styrene in said styrene-ethylene/propylene-styene(SEPS) is ranged between 10-50%, MFR ranged between 1.0-15.0 g/10 min, specific weight 0.85-0.95 g/cm³ and Shore hardness 40A-90A.

22. The protective film according to claim 16, wherein a MFR of polyolefin elastomer(POE) is ranged between 1.0-10.0 g/10 min, specific weight 0.80-0.90 g/cm³ and Shore hardness 50A-90A.

23. The protective film according to claim 16, wherein a MFR of ethylene vinyle acetate(EVA) is ranged between 1.0-20.0 g/10 min, specific weight 0.90-0.95 g/cm³ and Shore hardness 30A-90A.

24. The protective film according to claim 16, wherein said adhesion layer is added with hydrocarbon tackifier resin with specific weight ranged between 0.95-1.00 g/cm, softening point 70-140° C., and glass transition temperature(Tg) 35-90° C.

25. The protective film according to claim 24, wherein an added amount of said hydrocarbon tackifier resin is larger than 0 and smaller than 70% by weight of said adhesion layer.

26. The protective film according to claim 24, wherein an added amount of said hydrocarbon tackifier resin preferably is ranged between 10-65% by weight of said adhesion layer.

27. The protective film according to claim 24, wherein an added amount of said hydrocarbon tackifier resin more preferably is ranged between 15-60% by weight of said adhesion layer.
